(19) United States
(12) Patent Application Publication
(10) Pub. No.: US 2020/0037790 A1
(43) Pub. Date: Feb. 6, 2020

(54) Magnetic Mounting and Storage System

(71) Applicant: Andrew Veltz, Chesapeake Beach, MD (US)

(72) Inventor: Andrew Veltz, Chesapeake Beach, MD (US)

(21) Appl. No.: 16/532,394

(22) Filed: Aug. 5, 2019

Related U.S. Application Data
(60) Provisional application No. 62/714,334, filed on Aug. 3, 2018.

(51) Int. Cl. A47G 1/17; B25H 3/00; A47G 29/093; A47G 29/087; F16B 1/00; F16M 13/02

(52) U.S. Cl. CPC A47G 1/17; B25H 3/00; A47G 29/093; F16B 2001/0035; F16B 1/00; F16M 13/022; A47G 29/087

(57) ABSTRACT

A magnetic mounting system is described. The system is equipped with at least one magnet which is configured to be mounted to a wall or similar planar surface. A second retaining magnet, or metallic component, is configured to mate with the at least one magnet. The system is configured to mount objects such as artwork, canvas, posters, certificates, and other objects conventionally hung on walls. Similarly, other embodiments of the present invention are configured to mount other objects to a planar surface, such as keys, a mobile device, hygienic tools (such as mounted within a medicine cabinet).

This application is a non-provisional patent application of provisional patent application No. 62/714,334, filed on Aug. 3, 2018, and priority is claimed thereto.

### FIELD OF THE PRESENT INVENTION

The present invention relates to a system for mounting and/or storing objects to a planar surface, and more specifically relates to magnetic mounting and/or storing system configured for interchangeable, rapid mounting and/or storing of objects to planar surfaces such as walls, fences, cabinets, bricks, countertops, floors, ceilings, building exteriors, truck trailers, etc.

### BACKGROUND OF THE PRESENT INVENTION

Generally speaking, objects such as artwork, pictures, mirrors, pots, pans, tools, and other similar items are conventionally displayed or stored on planar surfaces such as walls or within enclosed structures such as closets or cabinets. A majority of the time, a decision to display artwork or a similar item in one's home or office or effort to store household or vocational tools often required damaging the wall by drilling one or more holes to secure the picture, painting, or poster, and/or routinely organizing household or vocational items conventionally by putting them in a closet. This normally would indicate the final destination for the item for the entirety of one's occupation of the structure (house, apartment, office, dorm, etc.). The interchangeability of the mounted item is also limited, especially in usage cases in which multiple mounting brackets, nails, screws, or tacks, are employed, as the new item may only require a single mount, or may need to be repositioned (requiring new holes to be made in the wall) in order to be centered or otherwise look appealing.

If there were a way to mount objects to the wall securely, while minimizing damage to the wall, and facilitating exchange of wall items without the use of tools, the process of accentuating ones home, as well as modifying the appearance at will would be much easier.

Additionally, conventional mounting mechanisms such as nails, picture mounts, wire cord mounting systems, and similar systems are generally limited such that the picture or artistic work often remains in the originally mounted position for the duration of ownership. If there were a system that facilitated rapid and damage-free exchange of items, decorating and customizing ones household on a semi-regular basis would be facilitated.

Other items, such as keys, mobile devices, clipboards, scissors, utensils, and other common items are also conducive to mounting effectively via a magnetic system. As such, if there were a system that employed a cohesive magnetic mounting and storing system to mount such items, more items may be securely stored, saving space, and adding versatility to certain planar surfaces such as the inside of cabinets, the sides of furniture, or a concrete wall such as within a garage or basement.

Thus, there is a need for new form of object-to-surface mounting and storage system which minimizes wall damage, facilitates ease of item replacement, and enables easier exchange of objects/items. Such a system preferably employs a series of magnets configured to facilitate the mounting of items such as artwork to a planar surface such as a wall.

While some features of the present invention are found within other object mounting and item storage systems, the present invention offers the unique versatility of moving the object without necessitating the creation of new holes, and with a larger scope of items that may be securely held to the wall or similar planar surface. Additionally, the system of the present invention creates a three-dimensional depth effect by raising the object off of the wall by several inches, making it appear as though it is hovering off of the wall.

### SUMMARY OF THE PRESENT INVENTION

The present invention is a magnetic mounting system configured to facilitate mounting of objects and artistic items to a wall or other planar surface such as a fence, cabinet, wood, or other surfaces. The present invention employs at least one magnetic mount, coupled with a retaining magnet. The magnet mount is affixed to the planar surface via a damage-free adhesive strip or a screw, and the retaining magnet is used to retain the object to be mounted and/or stored when it is held between the magnet mount and the retaining magnet. The magnetic field of the magnet mount is strong enough such that it extends through the object to the retaining magnet. In some embodiments of the present invention, the retaining magnet may be composed of a magnetic metal, and need not be a permanent magnet.

Via the mounting and storing system of the present invention, other objects such as keys, mobile devices, hygienic tools, clipboards, or other common items equipped with a metallic component may be mounted to a magnetic mount of the present invention to securely hold (and thereby store) the object(s) in position.

In short, the present invention amounts to a magnetic mounting and securing system, configured for a variety of uses in both the horizontal and vertical positions to be fixed on the outside or inside of a poster, artwork, picture, or similar item. Embodiments employing the magnetic mounting system of the present invention include, but are not limited to: a MagnaMounter equipped with a single, heavy duty magnetized post, a MagnaBar embodied in a elongated magnetic bar to be mounted in a horizontal position to hold tools and utensils, a MagnaMat for use in a flat, horizontal orientation, such as on a table, a MagnaBowl, a MagnaPlate, MagnaWare, a MagnaCup, MagnaClips, a MagnaWall, and a MagnaBrick. The features of the present invention are described in detail in the detailed description portion of the application.

### BRIEF DESCRIPTION OF THE DRAWINGS

The present invention will be better understood with reference to the appended drawing sheets, wherein:

FIG. 1 exhibits a front, top view of the magnetic mounting and storage system of the present invention, isolated from a planar surface and item to be mounted.

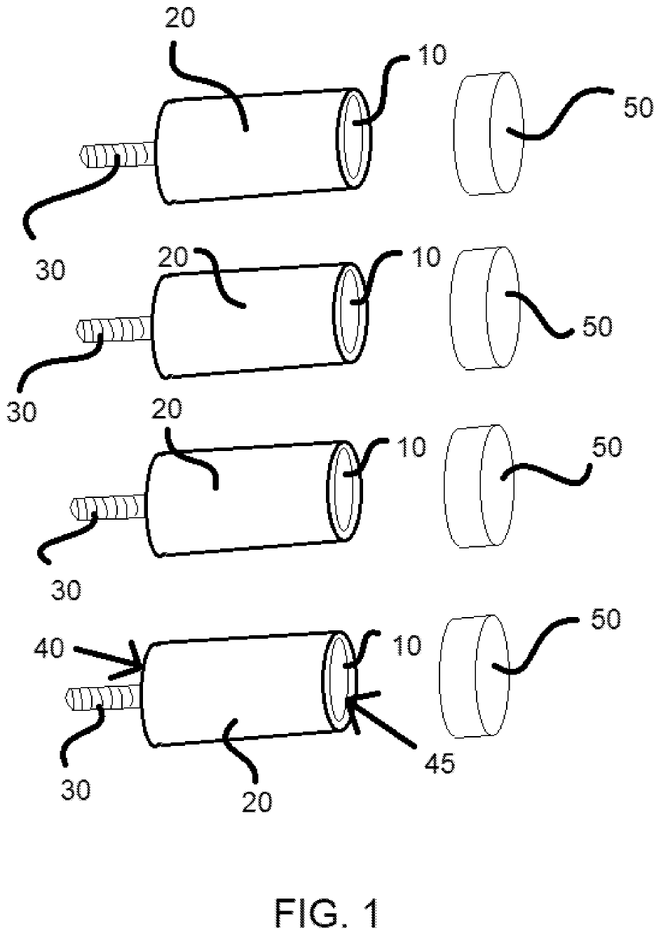

FIG. 2 depicts a view of the magnetic mounting and storage system of the present invention in use to mount a picture to the planar surface of a wall.

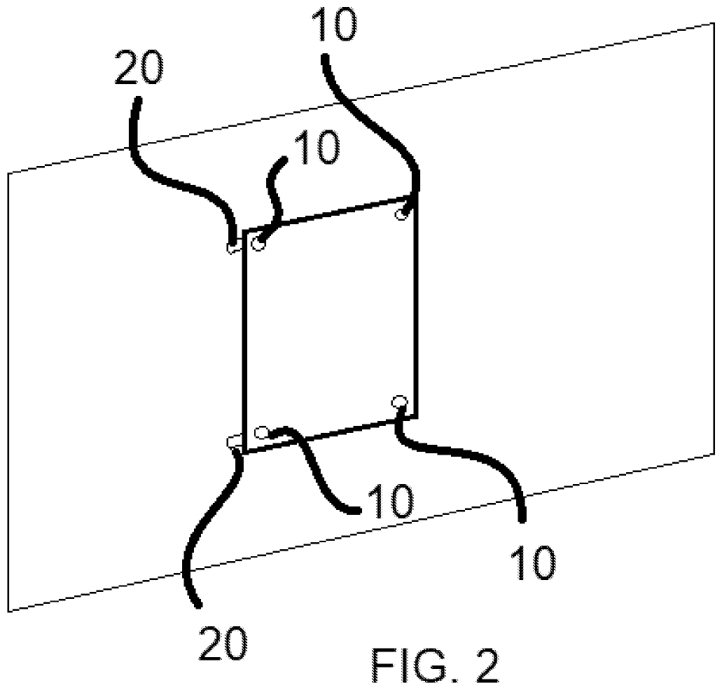

FIG. 3 displays a view of an alternate embodiment of the present invention, equipped with damage-free adhesive strips for damage-free installation of the apparatus.

FIG. 4 shows a flow chart of the process of installation and use of the present invention.

### DETAILED DESCRIPTION OF THE PREFERRED EMBODIMENT

The present invention is a magnetic mounting and storage system for mounting objects such as framed posters, artwork, pictures, banners, t-shirts, wooden framed artwork, metallic art, certificates, and similar items conventionally hung on a wall or similar planar surface. The present invention may be used for mounting and ultimately storing other items, such as lightweight shelves, key holders, hygienic tools (such as tweezers, clippers, etc), a mobile device, a clipboard, metallic signs, or other similar item.

The present invention employs a wall mount magnet (10) which is preferably ensconced within a cylindrical shaft (20), disposed at a front side (45) of the shaft (20). The shaft (20) is preferably equipped with a screw (30) or other mounting mechanism disposed on a rear side (40) of the shaft (20). The screw (30) is configured mount the shaft (20) to a wall or other planar surface of a structure. The screw (30) may be used with drywall anchors or similar anchor mounts. Alternately, the screw (30) may mount the shaft directly to a stud of the wall. The shaft (20) is configured to raise the item or object away from the wall in order to provide a three-dimensional depth effect when the object is affixed to the mount magnet (10). The mount magnet (10), coupled with the shaft (20) and the screw (30) are referenced as a ‘MagnaPost.’ In alternate embodiments of the present invention, the shaft (20) need not be cylindrical in nature, but may be square, rectangular, octagonal, etc.

Additionally, the present invention is equipped with retaining magnets (50), referenced as MagnaToppers, which are configured to be positioned such that the object or item to be mounted and/or stored is disposed between the mount magnets (10) and the retaining magnets (50). In some embodiments of the present invention, the retaining magnet (50) need not be a permanent magnet, but may instead be any sufficiently strong magnetic metal with a high degree of magnetism.

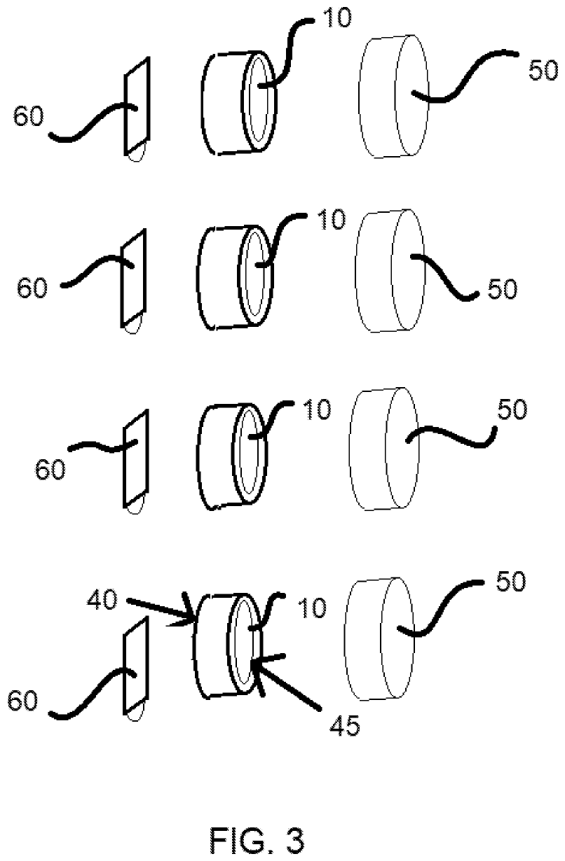

A second embodiment of the mounting system of the present invention, depicted in FIG. 3, employs adhesive strips (60) in lieu of a screw (30) to affix the mount magnet (10) to the planar surface. Such embodiments facilitate a damage-free option to mount items to a wall. However, the shaft (20) is preferably not present (or not as elongated) in such embodiments in order to ensure sufficient cohesion of the adhesive strip (60) to the planar surface when the weight of the object to be mounted is added.

A third embodiment of the present invention amounts to a single iteration of the mount magnet (10) of the present invention. Such an embodiment is configured to hold and store other objects such as keys and mobile devices via a single, heavy duty magnetized post embodied in a single iteration of the mount magnet (10) and shaft (20) of the present invention, referenced as a ‘MagnaMounter.’

A fourth alternate embodiment of the present invention employs an oversized magnetized metallic panel, planar in form, which is configured to be affixed via conventional means to a wall or similar surface. Such an embodiment is envisioned to be of use within industrial kitchens and/or repair shops for the storage and retention of tools, metallic cooking pots, pans, lids, knives, and other similar metallic utensils. The magnetized metallic panel, referenced as a ‘MagnaWall,’ is preferably equipped with magnets disposed throughout the panel, magnetizing the entirety of the panel.

A fifth alternate embodiment of the present invention is embodied via a horizontal stability system configured to retain and store objects in an ideal location of utility, such as atop a table. In such instances, at least one magnet is disposed within a flat horizontal surface, such as within a table. The at least one magnet is configured to mate with a similarly sized magnet housed within a base of an item such as a bowl, plate, or cup. It is envisioned that such an embodiment aids in the prevention of spills of plates (referenced as MagnaPlates), bowls (referenced as MagnaBowls), and cups (referenced as MagnaCups), especially those in use by a child. It is similarly envisioned that forks, knives, and spoons may also employ such a system when equipped with a magnetized handle. In such instances, the magnetized handle of the utensil (referenced as MagnaWare) ensures that the utensil remains in a set position when arranged atop the at least one magnet housed within the table.

A sixth embodiment of the magnetic mounting and storing system of the present invention employs at least one magnet housed within a flexible mat (referenced as a MagnaMat) for use over top of a table such as a kitchen table or coffee table. Such a flexible mat is equipped with a series of magnetic bits disposed throughout the flexible mat. The magnetic bits are envisioned to pair with a magnetic component of toys such as figurines in order to maintain the toy in an upright and stable position during play.

A seventh embodiment of the magnetic mounting and storing system of the present invention exhibits an elongated magnetic bar envisioned to be mounted in a horizontal orientation on a planar surface. The elongated magnetic bar is configured to facilitate the mounting and inherent storing of tools, such as within a garage, to temporarily mount metallic items such as hammers, screwdrivers, etc. Similarly, the elongated magnetic bar embodiment of the present invention may be of use within a kitchen to temporarily mount utensils such as a ladle, knives, forks, spoons, and other conventional kitchen items having a metallic component. It is envisioned the elongated magnetic bar embodiment may also be deployed within an office, or on the inside door/panel of a cabinet to store accessories such as scissors, pens, and other needed items secure and close-at-hand until needed.

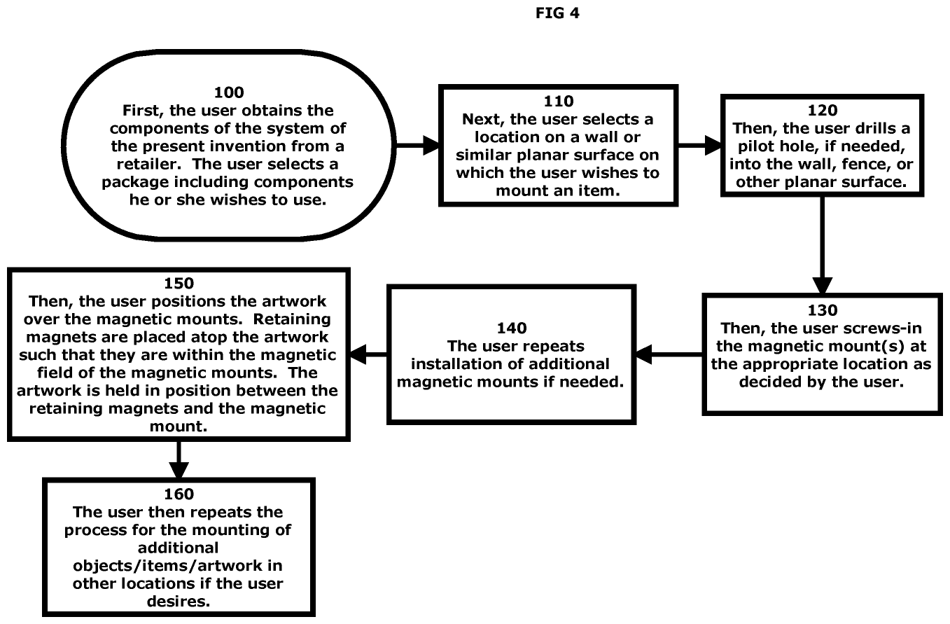

The process of installation and use of the system of the present invention, as depicted in FIG. 4, is preferably as follows:
1. First, the user obtains the components of the system of the present invention from a retailer. The user selects a package including components he or she wishes to use. (100)
2. Next, the user selects a location on a wall or similar planar surface on which the user wishes to mount an item. (110) If the item is a canvas artwork, poster, or similar artistic depiction, the user has selected the MagnaMount hardware package.
3. Then, the user drills a pilot hole, if needed, into the wall, fence, or other planar surface. (120)
4. Then, the user screws-in the magnetic mount(s) at the appropriate location as decided by the user. (130) The shaft of the magnetic mount is preferably screwed in far enough such that the base of the shaft is flush with the wall or other planar surface. Alternately, a damage-free adhesive strip (60) may be used to affix the mount magnet (10) to the planar surface. In such embodiments, a shaft of the mount magnet (10) is preferably not present to help ensure that the adhesive of the adhesive strip (60) may sufficiently hold the object to the planar surface.
5. The user repeats installation of additional magnetic mounts if needed. (140) For example, the user may wish to have four magnetic mounts, each disposed at a corner of a canvas or poster print artwork.
6. Then, the user positions the artwork over the magnetic mounts. Retaining magnets are placed atop the artwork such that they are within the magnetic field of the magnetic mounts. The artwork is held in position between the retaining magnets and the magnetic mount. (150)
7. The user then repeats the process for the mounting of additional objects/items/artwork in other locations if the user desires. (160)

It should be understood that the system of the present invention is not limited to the mounting of depictions of artistic expression, and may also be used to mount and store a variety of tools, household items, and other products commonly found within the home, office, or workplace. For items equipped with a metallic component, such as the clip of a clipboard, a retaining magnet (50) is not required.

It should be noted that retaining magnet (50) of the present invention may be configured to adhere to either the outside or inside of a poster, artwork, picture, or similar item. In cases in which the retaining magnet (50) is disposed on the inside (underneath, on the back) of the poster, artwork, or other item, the retaining magnet (50) is preferably adhered to the item via an adhesive. In these instances, the front of the poster or other item is not blemished by the presence of the retaining magnet (50) on the front of the poster or other item, but instead is hidden behind the item.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A mounting apparatus for mounting an item to a planar surface comprising:
a wall mount magnet;
a retaining magnet;
a cylindrical shaft;
wherein said wall mount magnet is ensconced within said cylindrical shaft;
a screw, said screw disposed in communication with said cylindrical shaft;
wherein the item is disposed and held between said wall mount magnet and said retaining magnet; and
wherein said screw anchors said wall mount magnet to the planar surface.

2. A mounting apparatus for mounting an item to a vertical surface comprising:
a wall mount magnet;
a retaining magnet;
wherein said wall mount magnet is ensconced within said cylindrical shaft;
an adhesive, said adhesive disposed on a rear of said wall mount magnet;
wherein the adhesive is configured to adhere said wall mount magnet to the vertical surface;
wherein the item is disposed and held between said wall mount magnet and said retaining magnet; and
wherein said screw anchors said wall mount magnet to the vertical surface.
